(19) United States
(12) Patent Application Publication
(10) Pub. No.: US 2010/0147970 A1
(43) Pub. Date: Jun. 17, 2010

(54) Leakproof arrangement of a chocolate fountain

(76) Inventor: Mei-Hsiu Chang, Jhonghe City (TW)

Correspondence Address: ROSENBERG, KLEIN & LEE, 3458 ELLICOTT CENTER DRIVE-SUITE 101, ELLICOTT CITY, MD, 21043, US

(21) Appl. No.: 12/314,625

(22) Filed: Dec. 15, 2008

(51) Int. Cl. A01J 11/00

(52) U.S. Cl. 239/16

(57) ABSTRACT

A leakproof arrangement of a chocolate fountain includes a leakproof device tightly fastened within the through hole of the basin. The leakproof device has i) a base sealed to the periphery of the through hole of the basin; ii) a plurality of support frames disposed around the base; and iii) a shaft sleeve disposed at the center of the base, the joint between the shaft sleeve and the base being tightly sealed without any gaps, the height h2 of the shaft sleeve being greater than the maximal chocolate level h1, the connection end at the top of the shaft sleeve rising above the height h2 of the shaft sleeve. In this way, the melted chocolate will never flow over the shaft sleeve such that downward leakage may be avoided. As a result, the leakage of the melted chocolate is prevented, thereby ensuring a smooth operation of the transmission element as well as a prolonged service life.

### BACKGROUND OF THE INVENTION

1. Field of the Invention

The invention relates to a chocolate fountain, and more particularly, to an improvement against the leakage of melted chocolate from the basin.

2. Description of the Related Art

As shown in FIGS. 1 through 4, a few of chocolate machines 10 (U.S. Pat. No. 7,021,556, U.S. Pat. No. 7,383,746, U.S. Pat. No. 7,118,045 and U.S. Pat. No. 7,182,209) include a base 11 on which a basin 12 is disposed. A motor 13 is installed therein. An auger 15 is driven by the motor 13 via a transmission shaft 14 in rotation within a cylinder 16. As a result, the melted chocolate within the basin 12 can be brought upward along the cylinder 16 at the center in a screwed way to the top 17 of the chocolate fountain. Thereafter, the melted chocolate flows from the top of the chocolate fountain back to the basin 12. When the melted chocolate flows along the tiers, a chocolate waterfall effect is created.

No matter whether the motor 13 is laterally arranged (FIG. 2) or vertically arranged (FIG. 3), a shaft seal 19 has to be mounted at the connection between the transmission shaft 14 and the auger 15 for preventing the melted chocolate within the basin 12 from leakage. As shown in FIG. 4, the conventional shaft seal 19 includes a rubber sleeve 191 within a shaft hole at the bottom of the basin 12 through which the transmission shaft 14 passes. The rubber sleeve 191 is elastically and tightly mounted at the periphery of the transmission shaft 14 for preventing the melted chocolate (illustrated by dots) within the basin 12 from leakage.

After used for a long period, the shaft seal 19 of the shaft seal 19 creates a fatigue of elasticity such that the melted chocolate will leak into a bearing 192, thereby reducing the service life thereof. Moreover, the melted chocolate may leak into the base 11. Even, it may overflow from the housing and cause much trouble. Therefore, the conventional shaft seal requires further improvements.

### SUMMARY OF THE INVENTION

An object of the invention is to provide a leakproof arrangement of a chocolate fountain that prevents the melted chocolate from leakage.

Another object of the invention is to provide a leakproof arrangement of a chocolate fountain that the position of the shaft sleeve is higher than the level of the melted chocolate such that the melted chocolate never flows over the shaft sleeve during the rotation of the transmission shaft. As a result, a reliable protection from leakage is ensured.

In order to achieve the above-mentioned object, a leakproof arrangement of a chocolate fountain includes:

a) a base housing with a motor for driving a transmission shaft;

b) a support disposed at the top of the base housing, the support having a recessed portion at the center thereof, the transmission shaft passing through the recessed portion and rising above the base housing;

c) a basin disposed on the support and provided with a through hole at the center thereof, the basin being adapted to receive the melted chocolate, the melted chocolate having a maximal level of h1;

d) a leakproof device tightly fastened within the through hole of the basin and including:
i) a base sealed to the periphery of the through hole of the basin;
ii) a plurality of support frames disposed around the base; and
iii) a shaft sleeve disposed at the center of the base, the joint between the shaft sleeve and the base being tightly sealed without any gaps, the height h2 of the shaft sleeve being greater than the maximal chocolate level h1, the connection end at the top of the shaft sleeve rising above the height h2 of the shaft sleeve; and

e) a cylinder placed into the space defined by the support frames, a screw rod positioned within the cylinder, the screw rod having a hollow tube at the bottom thereof for mounting externally on the shaft sleeve, a connection piece being provided within the bottom of the hollow tube for fitting into the connection end of the transmission shaft such that the screw rod is brought into rotation when the transmission shaft passes through the shaft sleeve.

### BRIEF DESCRIPTION OF THE DRAWINGS

The accomplishment of this and other objects of the invention will become apparent from the following descriptions and its accompanying figures of which:

FIG. 1 is a perspective view of a conventional chocolate fountain;

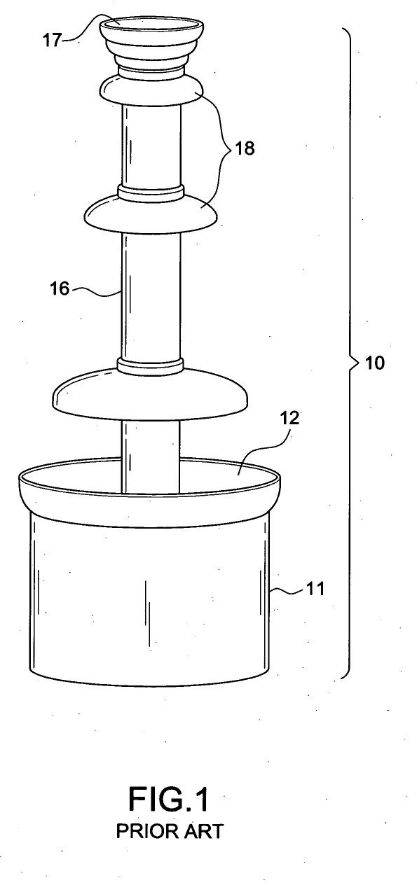

FIG. 2 is a cutaway view of the conventional chocolate fountain;

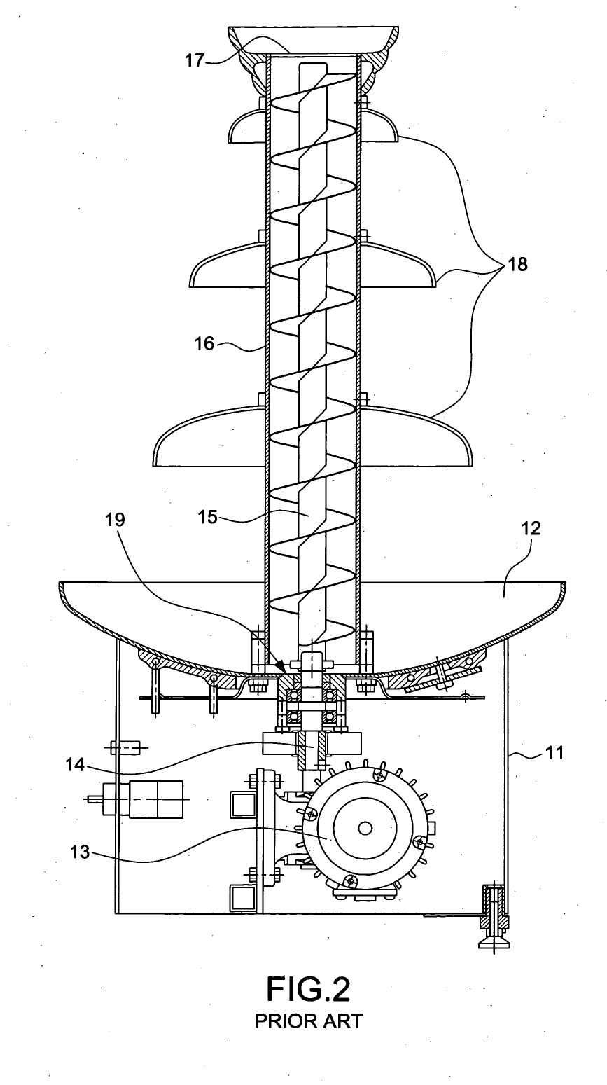

FIG. 3 is a cutaway view of another conventional chocolate fountain;

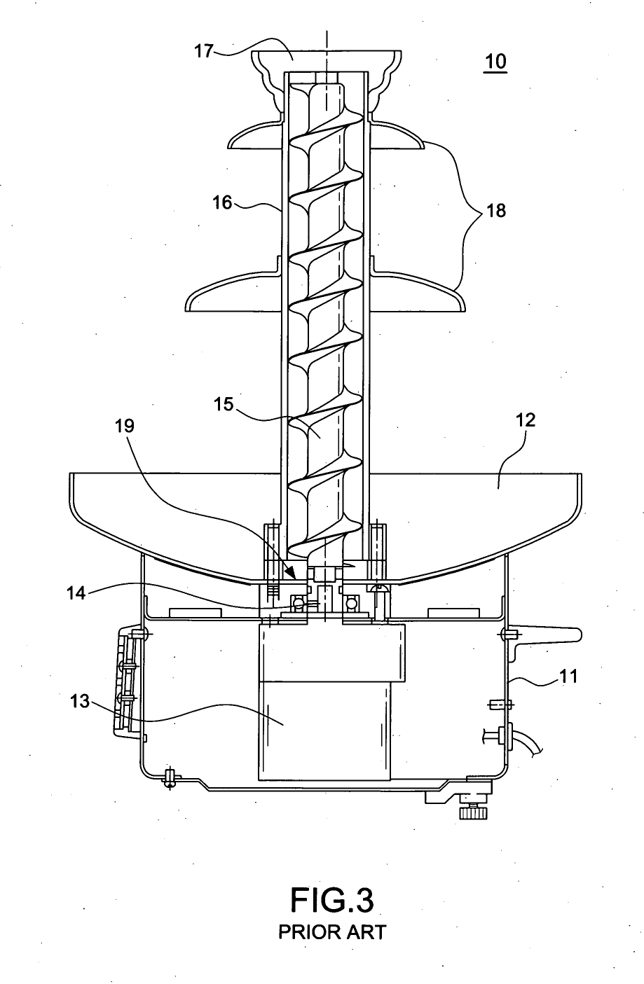

FIG. 4 is an enlarged cutaway view of a shaft seal of a conventional chocolate fountain;

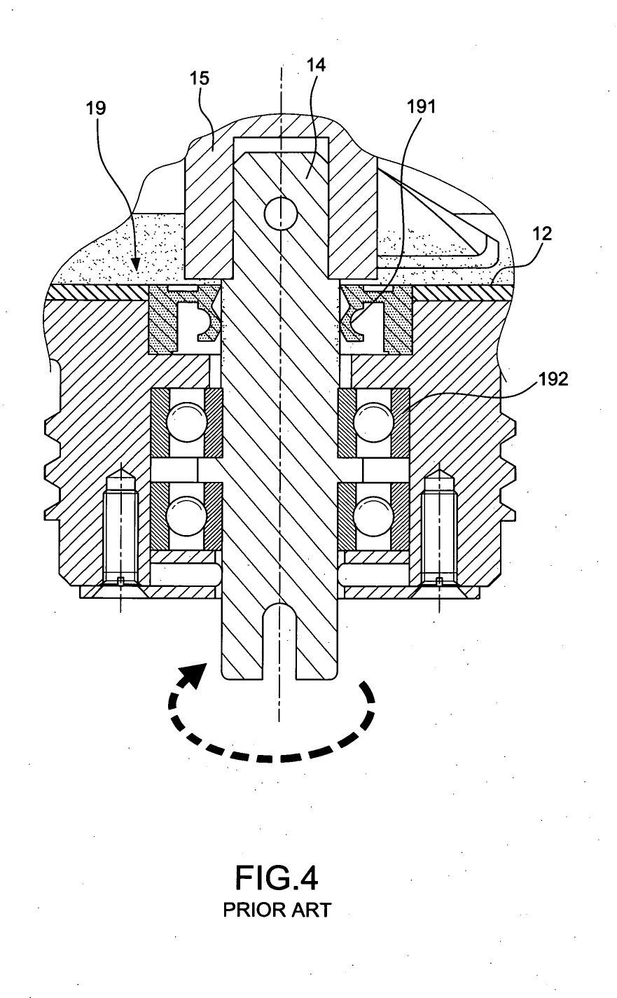

FIG. 5 is an exploded perspective view of a preferred embodiment in accordance with the invention;

FIG. 6 is an exploded perspective view of the main structure of a preferred embodiment in accordance with the invention;

FIG. 7 is a schematic assembly drawing of the main structure of the preferred embodiment in accordance with the invention; and

FIG. 8 is an enlarged cutaway view of the main structure according to FIG. 7.

### DETAILED DESCRIPTION OF THE PREFERRED EMBODIMENT

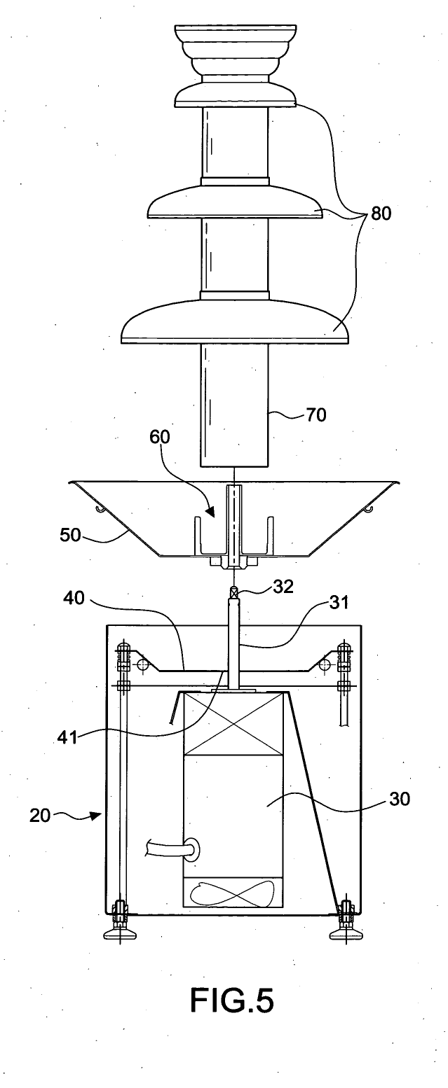

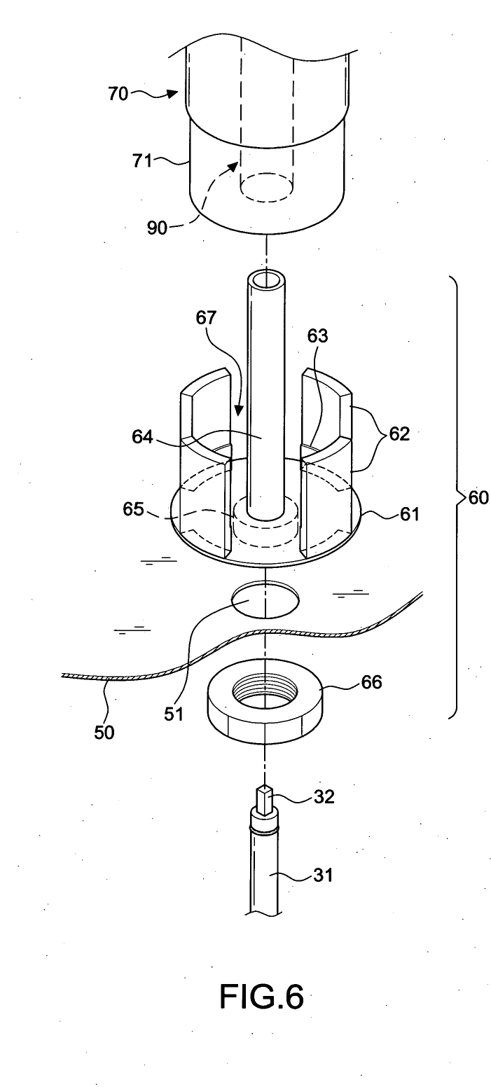

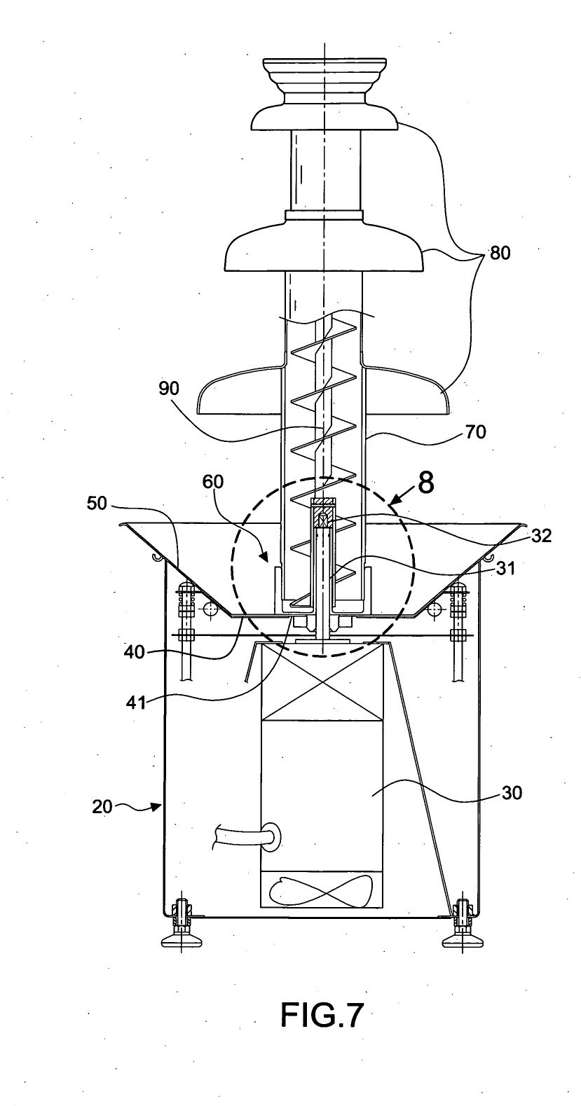

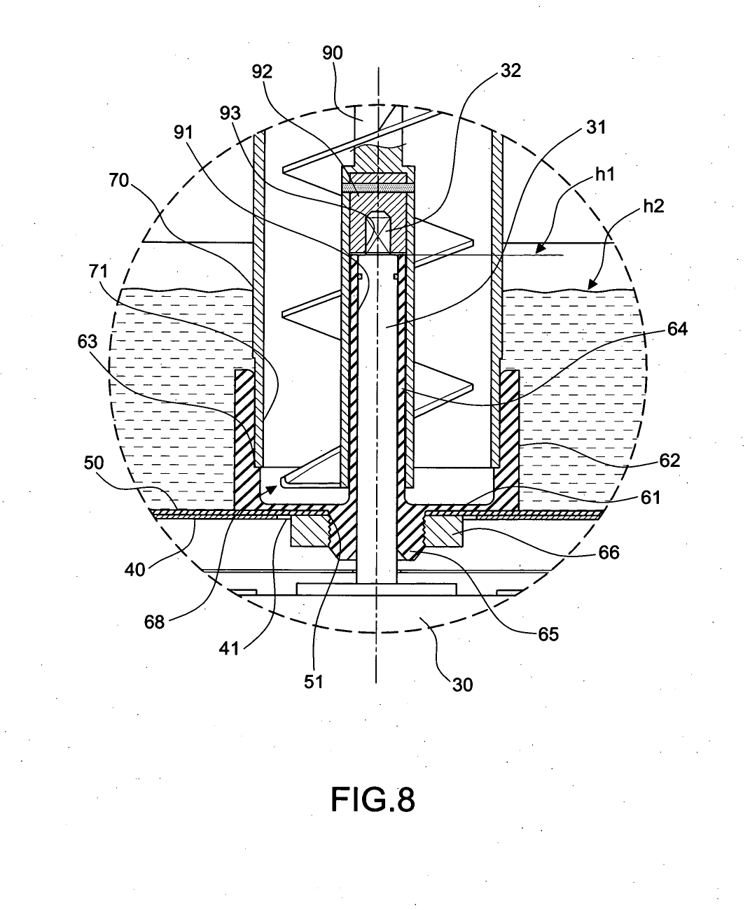

First of all, referring to FIGS. 5 through 8, a preferred embodiment of a leakproof arrangement of a chocolate fountain in accordance with the invention includes a base housing 20 with a motor 30 for driving a transmission shaft 31. A support 40 is disposed at the top of the base housing 20. As shown in FIG. 8, the support 40 includes a recessed portion 41 at the center thereof. The transmission shaft 31 passes through the recessed portion 41 and rises above the base housing 20. A basin 50 is disposed on the support 40 and provided with a through hole 51 at the center thereof (see FIG. 6). The basin 50 is adapted to receive the melted chocolate 100.

The primary object of the invention is to prevent the melted chocolate 100 leaking through the rim of the transmission shaft 31. In order to achieve this object, a shaft sleeve 64 higher than the maximal chocolate level h1 is provided. As shown in FIGS. 6 and 8, a leakproof device 60 is tightly fastened within the through hole 51 of the basin 50 and includes a base 61, a plurality of support frames 62, and a shaft sleeve 64.

The base 61 is sealed to the periphery of the through hole 51 of the basin 50. In order to achieve a better sealing effect, the base 61 should be many times as large as the through hole 51, thereby creating a sufficient contact surface. The base 61 is fixed to the basin 50 in such a way that it is not rotatable. As a result, the base 61 may be sealed and fixed in such a way that no leakage takes place.

The support frames 62 is disposed around the base 61 and integrally formed with the base 61. Alternatively, it may be fixed on the base 61. As shown in FIG. 6, the gaps between the support frames 62 are the passages for the entrance of the melted chocolate 100.

The shaft sleeve 64 is disposed at the center of the base 61. The joint between the shaft sleeve 64 and the base 61 is tightly sealed without any gaps. Moreover, the height h2 of the shaft sleeve 64 is greater than the maximal chocolate level h1. In addition, the connection end 32 at the top of the shaft sleeve 64 rises above the height h2 of the shaft sleeve 64.

The base 61 of the leakproof device 60 includes an externally threaded protrusion 65 at the bottom of the shaft sleeve 64. The protrusion 65 is fixed by a nut 66 after the protrusion 65 fits into the through hole 51 of the basin 50. It is preferred that the base 61, the shaft sleeve 64, and the protrusion 65 are integrally formed, but it should not be limited thereto.

The internal wall of the support frames 62 each is provided with a projecting portion 63. The projecting portions 63 have the same height relative to the bottom of the basin 50. The height of the support frames 62 lies between 3 to 6 cm. In this way, a bottom portion 71 having smaller diameter may be tightly fixed in place when a cylinder 70 is placed into the space defined by the support frames 62. As shown in FIG. 8, an empty space 68 is formed between the cylinder 70 and the bottom of the basin 50 such that the melted chocolate 100 can be transported to the top of the chocolate fountain by means of a screw rod 90 within the cylinder 70. Thereafter, the melted chocolate 100 flows from the top of the chocolate fountain via tiers 80 back to the basin 50.

The screw rod 90 includes a hollow tube 91 at the bottom thereof. A connection piece 92 is provided within the bottom of the hollow tube 91. When the screw rod 90 is mounted on the shaft sleeve 64, the connection end 32 of the transmission shaft 31 of the motor 30 projects from the shaft sleeve 64. Moreover, the connection end 32 is formed in a non-circular shape while the connection piece 92 is formed as a corresponding and non-circular slot 93. In this way, the connection end 32 may fits into the slot 93 so that the screw rod 90 can be driven by the motor 30.

The invention features that the height h2 of the shaft sleeve 64 is greater than the maximal chocolate level h1. For example, the shaft sleeve 64 can be designed as high as 16 cm if the basin 50 permits that the maximal chocolate level h1 is 15 cm. In this way, the melted chocolate 100 will never flow over the shaft sleeve 64. Meanwhile, no leakage takes place since a sealing state between the bottom of the shaft sleeve 64 and the base 61 is ensured. As a result, gaps are only created at the top of the shaft sleeve 64 when the transmission shaft 31 brings the screw rod 90 in rotation. According to the invention, the height h2 of the shaft sleeve 64 is greater than the maximal chocolate level h1. Therefore, the problem created by the conventional shaft-sealing structure is resolved. In addition, the whole structure is more simple, and a better leakproof effect is achieved.

Many changes and modifications in the above-described embodiment of the invention can, of course, be carried out without departing from the scope thereof. Accordingly, to promote the progress in science and the useful arts, the invention is disclosed and is intended to be limited only by the scope of the appended claims.

What is claimed is:

1. A leakproof arrangement of a chocolate fountain, comprising:
a) a base housing with a motor for driving a transmission shaft;
b) a support disposed at the top of the base housing, the support having a recessed portion at the center thereof, the transmission shaft passing through the recessed portion and rising above the base housing;
c) a basin disposed on the support and provided with a through hole at the center thereof, the basin being adapted to receive the melted chocolate, the melted chocolate having a maximal level of h1;
d) a leakproof device tightly fastened within the through hole of the basin and including:
i) a base sealed to the periphery of the through hole of the basin;
ii) a plurality of support frames disposed around the base; and
iii) a shaft sleeve disposed at the center of the base, the joint between the shaft sleeve and the base being tightly sealed without any gaps, the height h2 of the shaft sleeve being greater than the maximal chocolate level h1, the connection end at the top of the shaft sleeve rising above the height h2 of the shaft sleeve; and
e) a cylinder placed into the space defined by the support frames, a screw rod positioned within the cylinder, the screw rod having a hollow tube at the bottom thereof for mounting externally on the shaft sleeve, a connection piece being provided within the bottom of the hollow tube for fitting into the connection end of the transmission shaft such that the screw rod is brought into rotation when the transmission shaft passes through the shaft sleeve.

2. The leakproof arrangement of a chocolate fountain as recited in claim 1 wherein the base of the leakproof device includes an externally threaded protrusion at the bottom of the shaft sleeve, and wherein the protrusion is fixed by a nut after the protrusion fits into the through hole of the basin.

3. The leakproof arrangement of a chocolate fountain as recited in claim 2 wherein the base, the shaft sleeve, and the protrusion are integrally formed.

4. The leakproof arrangement of a chocolate fountain as recited in claim 1 wherein the internal wall of the support frames of the leakproof device each is provided with a projecting portion, and wherein the projecting portions have the same height relative to the bottom of the basin, and wherein a bottom portion having smaller diameter may be tightly fixed in place when a cylinder is placed into the space defined by the support frames

5. The leakproof arrangement of a chocolate fountain as recited in claim 1 wherein the connection end of the transmission shaft of the motor is formed in a non-circular shape while the connection piece within the screw rod is formed as a non-circular slot.

6. The leakproof arrangement of a chocolate fountain as recited in claim 1 wherein the gaps between the support frames are the passages for the entrance of the melted chocolate.
